(19) United States
(12) Patent Application Publication
(10) Pub. No.: US 2016/0017815 A1
(43) Pub. Date: Jan. 21, 2016

(54) EXPANDING SHELL FLOW CONTROL DEVICE

(71) Applicant: UNITED TECHNOLOGIES CORPORATION, Hartford, CT (US)

(72) Inventors: Felix Izquierdo, Boynton Beach, FL (US); Timothy J. McAlice, Jupiter, FL (US)

(21) Appl. No.: 14/772,933

(22) PCT Filed: Mar. 11, 2014
(86) PCT No.: PCT/US14/22924

§ 371 Date: Sep. 4, 2015

Related U.S. Application Data
(60) Provisional application No. 61/777,306, filed on Mar. 12, 2013.

(51) Int. Cl. F02C 9/22; F02C 9/18; F02C 3/04

(52) U.S. Cl. CPC F02C 9/22; F02C 3/04; F02C 9/18; F05D 2220/32; F05D 2240/35; F05D 2240/128; F05D 2260/606

(57) ABSTRACT

A gas turbine engine includes a bypass flowpath between an outer engine case structure and a core engine. The bypass flow exits the engine through a nozzle. A flow control device that can expand or contract is arranged around the nozzle to control the bypass flow and includes a plurality of overlapping arcuate segments. A method of controlling a bypass flow includes providing a flow control device with overlapping segments that defines a bypass flow path, and actuating the segments to change the amount of overlap between segments and therefore the size of the bypass flow path.

### STATEMENT REGARDING FEDERALLY SPONSORED RESEARCH OR DEVELOPMENT

This invention was made with government support under contract number FA8650-09-D-2923 awarded by the United States Air Force. The government has certain rights in the invention.

### BACKGROUND OF THE INVENTION

This disclosure relates to an expanding shell bypass flow control device for a gas turbine engine.

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

Gas turbine engines typically include a bypass air stream that flows adjacent to a core engine section and exits the engine downstream of a fan through a nozzle. Bypass air can be used for cooling purposes or to provide additional thrust to the engine. The bypass air stream can be controlled by the nozzle, for example by altering the size or geometry of the area available for the bypass air to flow through. Certain states during a normal engine cycle can correspond to optimal aerodynamic flow characteristic of the bypass stream. Aerodynamic control of the bypass air stream can improve overall operability and efficiency of the gas turbine engine.

### SUMMARY OF THE INVENTION

In a featured embodiment, a gas turbine engine includes an outer engine case structure, a core engine arranged within the outer engine case structure, a nozzle downstream from the core engine, and a flow control device arranged around the nozzle and radially inward from the outer engine case structure, where the flow control device comprises a plurality of arcuate segments movable radially to vary a bypass flow area.

In another embodiment according to the previous embodiment, the gas turbine engine further includes a seal upstream from the flow control device.

In another embodiment according to any of the previous embodiments, the seal seals a cavity between the flow control device and a static engine structure upstream from the flow control device.

In another embodiment according to any of the previous embodiments, the plurality of arucate segments are metallic sheets.

In another embodiment according to any of the previous embodiments, the plurality of arcuate segments are slidable with respect to one another to vary an amount of overlap between the segments.

In another embodiment according to any of the previous embodiments, where increasing the amount of overlap between the arucate segments decreases a diameter of the flow control device.

In another embodiment according to any of the previous embodiments, where decreasing the amount of overlap between the arcuate segments increases a diameter of the flow control device.

In another embodiment according to any of the previous embodiments, the gas turbine engine includes a first bypass flow path about the core engine and a second bypass flow path disposed radially outward of the first bypass flow path, wherein the flow control device is in the second bypass flow path.

In another featured embodiment, a method of controlling bypass flow in a gas turbine engine comprises the steps of providing a flow control device arranged around a nozzle and radially inward from an outer engine case structure, where the flow control device includes a plurality of arcuate segments configured to overlap one another and the flow control device defines a bypass flow path, and sliding the plurality of arucate segments to change a bypass flow area.

In another embodiment according to any of the previous embodiments, the method of controlling bypass flow additionally comprises the step of actuating a seal, where the seal is arranged upstream from the flow control device.

In another embodiment according to any of the previous embodiments, moving the plurality of arcuate segments relative to one another increases the amount of overlap and increases the bypass flow path area.

In another embodiment according to any of the previous embodiments, sliding the segments relative to one another to decrease the amount of overlap between the plurality of arcuate segments and decreases the bypass flow path area.

In another featured embodiment, a nozzle assembly for a gas turbine engine includes a first bypass flowpath, a second bypass flowpath radially outward of the first bypass flow path, and a flow control device arranged around the nozzle assembly and radially inward from an outer engine case structure, where the flow control device comprises a plurality of arcuate segments movable radially to vary a bypass flow area.

In another embodiment according to any of the previous embodiments, the plurality of arucate segments are metallic sheets.

In another embodiment according to any of the previous embodiments, the plurality of arcuate segments are slidable with respect to one another to vary an amount of overlap between the segments.

In another embodiment according to any of the previous embodiments, increasing the amount of overlap between the arucate segments decreases a diameter of the flow control device.

In another embodiment according to any of the previous embodiments, decreasing the amount of overlap between the arcuate segments increases a diameter of the flow control device.

These and other features can be best understood from the following specification and drawings, the following of which is a brief description.

### BRIEF DESCRIPTION OF THE DRAWINGS

FIG. 1a illustrates a schematic gas turbine engine.

FIG. 1b illustrates a schematic detail view of the bypass flows of FIG. 1a.

FIG. 2a illustrates a schematic bypass flow control device in the open position.

FIG. 2b is a detail view of the schematic bypass flow control device of FIG. 2a.

FIG. 3a illustrates a schematic bypass flow control device in the closed position.

FIG. 3b is a detail view of the schematic bypass flow control device of FIG. 3a.

FIG. 4 illustrates a side view of the schematic flow control device.

FIG. 5a illustrates a front view of the schematic bypass flow control device in the open position.

FIG. 5b illustrates a front view of the schematic bypass flow control device in the closed position.

### DETAILED DESCRIPTION

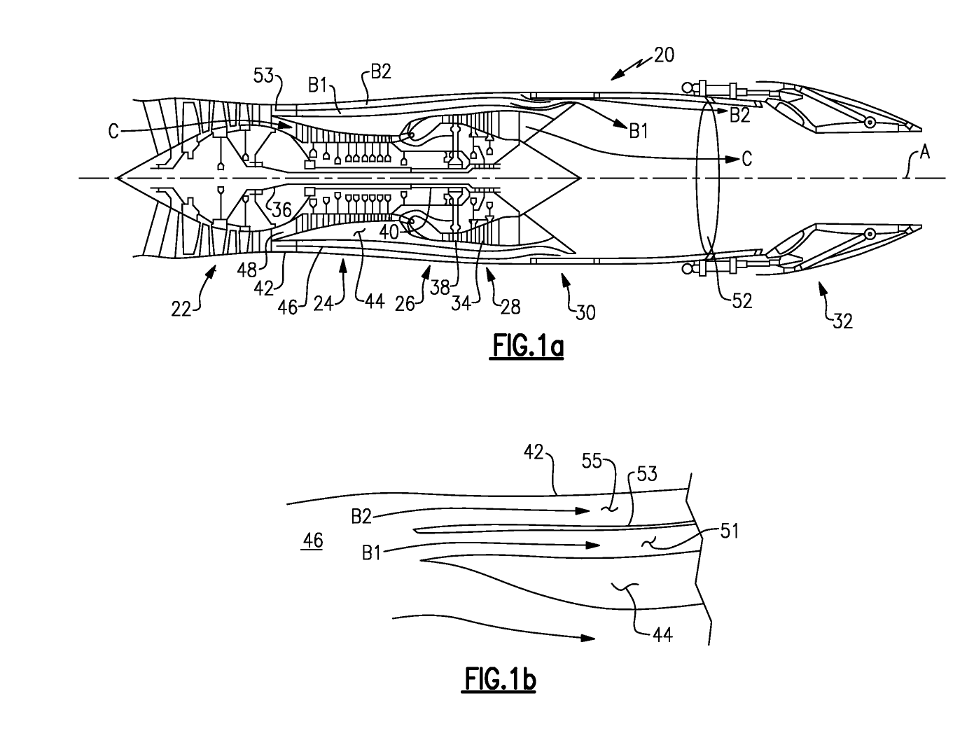

FIG. 1a schematically illustrates a gas turbine engine 20. The gas turbine engine 20 generally incorporates a fan section 22, a compressor section 24, a combustor section 26, a turbine section 28, an augmenter section 30 and a nozzle section 32. The sections are defined along a central longitudinal engine axis A. Although depicted as an augmented low bypass gas turbine engine in the disclosed non-limiting embodiment, it should be understood that the concepts described herein are applicable to other gas turbine engines including geared architecture engines, direct drive turbofans, turboshaft engines and others.

The compressor section 24, the combustor section 26 and the turbine section 28 are generally referred to as the engine core. The fan section 22 and a low pressure turbine 34 of the turbine section 28 are coupled by a first shaft 36 to define a low spool. The compressor section 24 and a high pressure turbine 38 of the turbine section 28 are coupled by a second shaft 40 to define a high spool.

An outer engine case structure 42 and an inner engine structure 44 define a generally annular secondary flow path 46 around a core flow path 48 of the engine core. It should be understood that various structure within the engine may define the outer engine case structure 42 and the inner engine structure 44 which essentially define an exoskeleton to support the core engine therein.

Air which enters the fan section 22 is divided between the core air flow C through the core flow path 48 and a bypass air flow B through the secondary flow path 46. The core flow C passes through the combustor section 26, the turbine section 28, then the augmentor section 30 where fuel may be selectively injected and burned to generate additional thrust through the nozzle section 32. The bypass flow B may be utilized for a multiple of purposes to include, for example, cooling and pressurization, or to provide additional thrust. The bypass flow B passes through an annulus defined by the outer engine case structure 42 and the inner engine structure 44 then may be at least partially injected into the core flow C adjacent the nozzle section 32.

As is shown in FIG. 1b, in one example, the bypass flow B can further be separated into one or more bypass flow streams. For example, bypass air B can comprise bypass stream B1 and bypass stream B2 separated by a divider 53. Both bypass streams B1 and B2 flow through the annular secondary flowpath 46 between the inner engine structure 44 and the outer engine case structure 42. Bypass stream B1 flows adjacent to the inner engine structure 44 through bypass flowpath 51 while bypass stream B2 flows radially outward from bypass stream B1 through bypass flowpath 55 and adjacent to the outer engine case structure 42.

In one example, the flow control device 52 is a shell that can be arranged around the nozzle section 32 within the outer engine case structure 42. The nozzle 32 is a convergent/divergent nozzle, for example. The flow control device 52 can alter the aerodynamic properties of the bypass flow stream B2 by altering the annular area of bypass flowpath 55 available for bypass flow B2 to pass through. For example, the flow control device 52 can provide more or less bypass flow B2 during certain stages of an engine cycle to improve operability and efficiency of the engine 20.

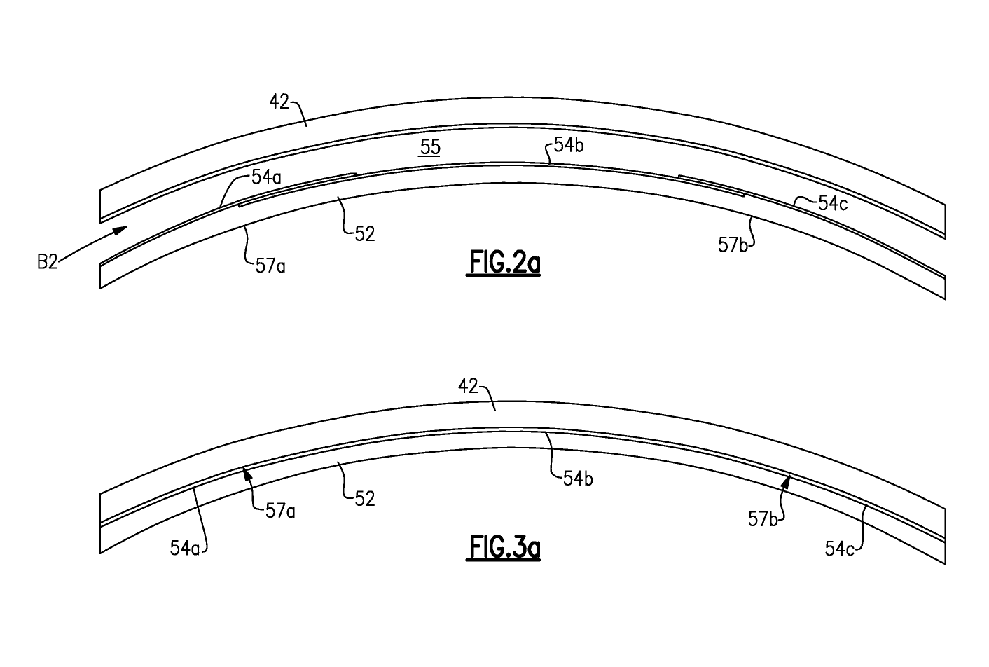

FIGS. 2a and 2b schematically illustrates the flow control device 52 in the open position. FIG. 2b shows a detail view of the flow control device 52 of FIG. 2a. The flow control device 52 comprises a plurality of segments 54a, 54b, 54c slidable relative to one another and arranged in a ring. The segments 54a, 54b, 54c can overlap one another, forming sliding joints 57a, 57b. The amount of overlap between the segments 54a, 54b, 54c determines the radius of the flow control device 52 and thus the size of the bypass flowpath 55 through which bypass air B2 can flow. For example, when the flow control device 52 is in the open position, the amount of overlap between segments is increased, and the flow control device 52 contracts. The bypass flowpath 55 allows bypass air B2 through when the flow control device 52 is in the open position. The segments 54a, 54b, 54c can be made of sheet metal, in one example.

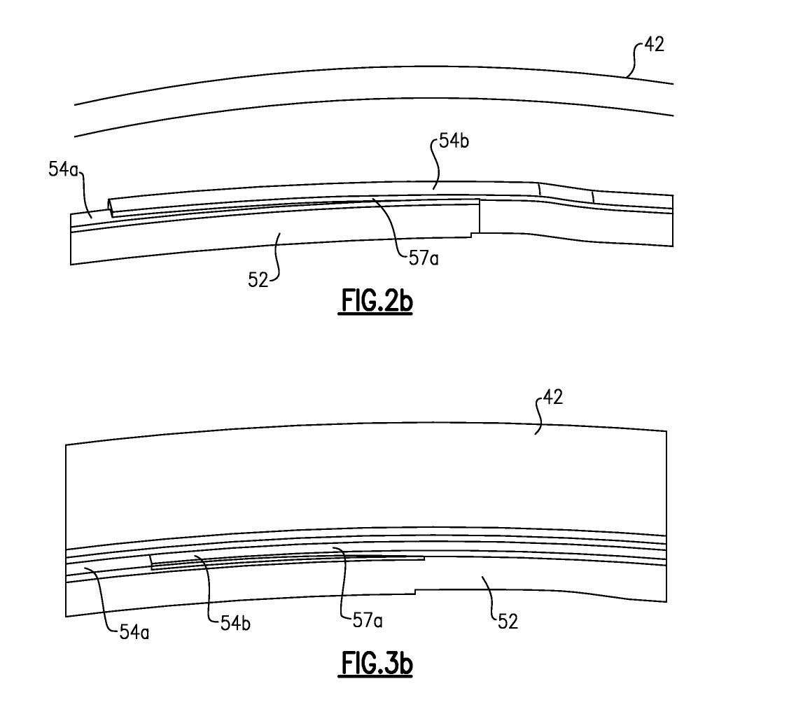

FIGS. 3a and 3b schematically illustrate the flow control device 52 in the closed position. FIG. 3b shows a detail view of the flow control device 52 of FIG. 3a. In the closed position, the amount of overlap between the segments 54a, 54b, 54c is decreased and the flow control device 52 expands radially outward towards the outer engine case structure 42. In the closed position, the bypass flowpath 55 is blocked off and no bypass air B2 can pass through.

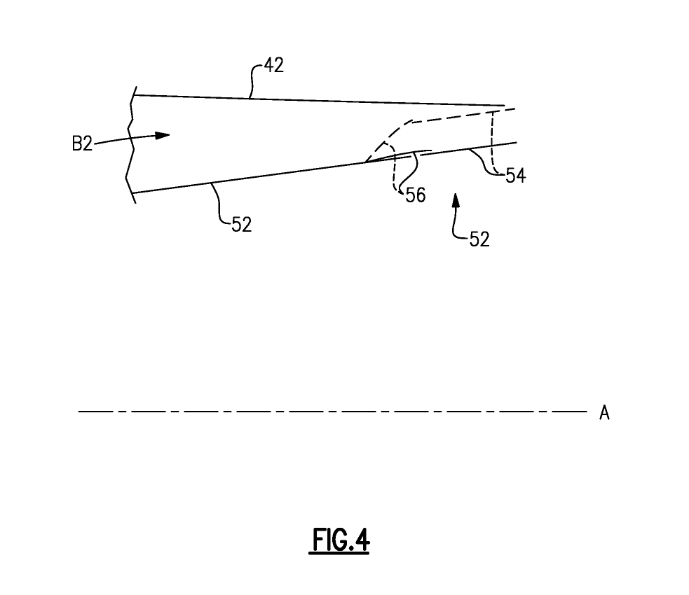

Referring to FIG. 4, a seal 56 can be present upstream of the segments 54 of the flow control device 52. The seal 56 can be a flex seal, for example. The seal 56 can seal a cavity between the flow control device 52 and static ducting structures upstream from the nozzle 32. The segment 54 and seal 56 are shown in the open position by the solid lines and in the closed position by the dashed lines.

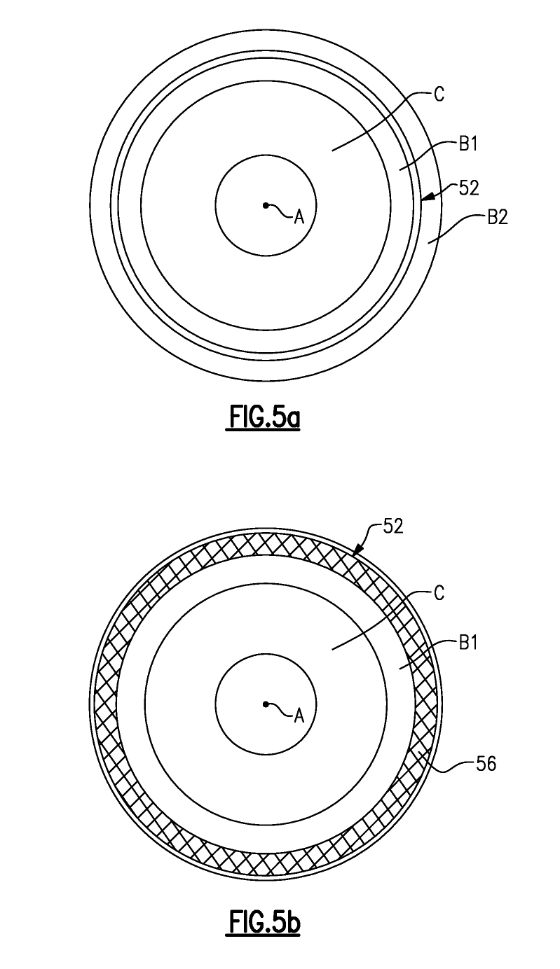

FIGS. 5a and 5b schematically illustrate a front view of the flow control device 52 in the open and closed positions, respectively.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A gas turbine engine, comprising:
an outer engine case structure;
a core engine arranged within the outer engine case structure;
a nozzle downstream from the core engine; and
a flow control device arranged around the nozzle and radially inward from the outer engine case structure, the flow control device comprising a plurality of arcuate segments movable radially to vary a bypass flow area.

2. The gas turbine engine of claim 1, further comprising a seal upstream from the flow control device.

3. The gas turbine engine of claim 2, wherein the seal seals a cavity between the flow control device and a static engine structure upstream from the flow control device.

4. The gas turbine engine of claim 1, wherein the plurality of arucate segments are metallic sheets.

5. The gas turbine engine of claim 1, wherein the plurality of arcuate segments are slidable with respect to one another to vary an amount of overlap between the segments.

6. The gas turbine engine of claim 5, wherein increasing the amount of overlap between the arucate segments decreases a diameter of the flow control device.

7. The gas turbine engine of claim 5, wherein decreasing the amount of overlap between the arcuate segments increases a diameter of the flow control device.

8. The gas turbine engine of claim 1, including a first bypass flow path about the core engine and a second bypass flow path disposed radially outward of the first bypass flow path, wherein the flow control device is in the second bypass flow path.

9. A method of controlling bypass flow in a gas turbine engine, comprising the steps of:
providing a flow control device arranged around a nozzle and radially inward from an outer engine case structure, the flow control device comprising a plurality of arcuate segments configured to overlap one another and defining the bypass flow path; and
sliding the plurality of arucate segments to change a bypass flow area.

10. The method of claim 9, additionally comprising the step of actuating a seal, the seal arranged upstream from the flow control device.

11. The method of claim 9, wherein moving the plurality of arcuate segments relative to one another increases the amount of overlap and increases the bypass flow path area.

12. The method of claim 9, wherein sliding the segments relative to one another to decrease the amount of overlap between the plurality of arcuate segments and decreases the bypass flow path area.

13. A nozzle assembly for a gas turbine engine comprising:
a first bypass flowpath,
a second bypass flowpath radially outward of the first bypass flow path; and
a flow control device arranged around the nozzle assembly and radially inward from an outer engine case structure, the flow control device comprising a plurality of arcuate segments movable radially to vary a bypass flow area.

14. The nozzle assembly of claim 13, wherein the plurality of arucate segments are metallic sheets.

15. The nozzle assembly of claim 13, wherein the plurality of arcuate segments are slidable with respect to one another to vary an amount of overlap between the segments.

16. The nozzle assembly of claim 15, wherein increasing the amount of overlap between the arucate segments decreases a diameter of the flow control device.

17. The nozzle assembly of claim 15, wherein decreasing the amount of overlap between the arcuate segments increases a diameter of the flow control device.
